(19) United States
(12) Patent Application Publication
(10) Pub. No.: US 2006/0278108 A1
(43) Pub. Date: Dec. 14, 2006

(54) Method of supplying ink to ink rollers in a printing press

(76) Inventor: Atsushi Sejima, Fuchu-shi (JP)

Correspondence Address: TECHNOLOGY & INTELLECTUAL PROPERTY STRATEGIES;(TIPS) GROUPS, P. O. BOX 1639, LOS ALTOS, CA, 94023-1639, US

(21) Appl. No.: 11/506,306

(22) Filed: Aug. 18, 2006

Related U.S. Application Data
(62) Division of application No. 10/890,656, filed on Jul. 13, 2004.

(30) Foreign Application Priority Data
Jul. 16, 2003 (JP) 2003-197881

(51) Int. Cl. B41F 31/00

(52) U.S. Cl. 101/350.1

(57) ABSTRACT

A method of supplying a given amount of ink to ink rollers in a printing press in advance before starting a current printing operation to be subsequently made after a last printing operation, includes adjusting the amount of ink to be supplied to the ink rollers in advance before starting the current printing operation, according to the time elapsed between the end of the last printing operation and the start of the current printing operation.

### CROSS REFERENCE TO RELATED APPLICATION

This application claims priority from Japanese Patent Application No. 2003-197881, which is incorporated herein by reference.

### BACKGROUND OF THE INVENTION

1. Field of the Invention

The present invention relates to an improvement in a method of supplying ink to ink rollers in a printing press.

2. Related Art

Between the end of one printing operation and the start of the next printing operation, preliminary works such as blanket cylinder washing and printing plate replacement must be made. Also, before starting the next printing operation, the opening degrees of ink fountain keys are preset based on the image area ratio of a new printing plate used for the next printing operation. Another work recently made in addition to these preliminary works conventionally made is to build up a distribution of the ink film thickness on each of the ink rollers for the next printing operation every time a printing operation is finished to compensate for ink film that was used for the last printing operation and still remains on the ink rollers (cf. Japanese Patent Laid-open No. Hei-11-5297).

After the start of the printing operation, the prints as produced are checked such as by picking up a single or some prints from them and measuring the print density, so that where the print density or other relevant value is out of a target value, the amount of ink to be supplied is increased or decreased.

In the above conventional ink supply method, the following problems are caused.

First, before starting the next printing operation, ink on the ink rollers may be dried or its characteristic may be changed. Every time one printing operation is finished, sheet feeding and ink supply from an ink fountain are temporarily suspended. As a result, the characteristic of ink on the ink rollers changes as the time elapses so that the longer the time required to start the next operation, the greater the ink characteristic changes. During the intermission between the printing operations, the preliminary works by the operator such as printing plate replacement or blanket cylinder washing are made, or sometimes the operator takes a rest. For these preliminary works, the printing press does not perform its printing operation. The characteristic of ink left on the ink roller changes greatly or slightly, depending on the time elapsed since the end of the last printing operation. As a result, there may be caused an uneven film thickness distribution of ink to be built up on each ink roller for the next printing operation. Accordingly, the longer the time before the printing operation is started, the print density after starting the next printing operation tends to become lower. As a result, more broke is caused during the next printing operation.

Second, in a conventional printing operation, even when the print density is measured after the start of a printing operation, this printing operation is not suspended during this density measuring, and therefore broke is continuously caused. As a result, much broke is caused before the density reaches a target value.

In consideration of the above problems associated with the conventional printing operation, it is an object of the present invention to provide a method of supplying ink to ink rollers in a printing press that is capable of causing less broke than ever.

### SUMMARY OF THE INVENTION

According to one aspect of the present invention, there is provided a method of supplying a given amount of ink to ink rollers in a printing press in advance before starting a current printing operation to be subsequently made after a last printing operation, comprising adjusting the amount of ink to be supplied to the ink rollers in advance before starting the current printing operation, according to the time elapsed between the end of the last printing operation and the start of the current printing operation.

With the above method, in which the amount of ink to be supplied to the ink rollers is adjusted in advance before start of the current printing operation, according to the time elapsed between the end of the last printing operation and the start of the current printing operation, it is possible to prevent lowering of the print density after the start of the current printing operation and hence prevent broke as much as possible, even if the ink characteristic is greatly changed due to a relatively long time elapsed for preparation of the current printing operation or any other reason.

According to another aspect of the present invention, there is provided a method of supplying ink to ink rollers in a printing press comprising starting a printing operation, thereby producing a given number of prints, and suspending the printing operation, during which the print density for the given number of prints is measured, so that where the print density is lower than a target value, ink is supplied to the ink rollers with the printing operation kept suspended, and where the print density is higher than the target value, the printing operation is resumed while suspending ink supply to the ink rollers for a given time after resumption of the sheet feeding.

With the above method, in which the print density is measured while suspending the printing operation, it is possible to prevent the occurrence of broke during the density measuring. In addition, where ink is supplemented based on the measured result, the printing operation is kept suspended and where ink is reduced, the sheet feeding is kept suspended. As a result, it is also possible to prevent the occurrence of broke during the increase or decrease of the amount of ink after resumption of the printing operation.

### BRIEF DESCRIPTION OF THE DRAWINGS

The above, and other objects, features and advantages of the present invention will become apparent from the detailed description thereof in conjunction with the accompanying drawings wherein.

FIG. 1 is a schematic view of an essential portion of a printing press for explanation of the ink supply method according to one embodiment of the present invention.

FIGS. 2A and 2B are respectively model views illustrating the amount of ink adhered to an ink roller.

FIG. 2C is a graph illustrating one example of the amount of ink corresponding to an image of a printing plate.

FIGS. 2D, 2E and 2F are respectively model views illustrating the amount of ink in an ink roller group.

FIG. 3 is a flowchart of an ink supply process in one embodiment of the present invention.

### DETAILED DESCRIPTION OF THE PREFERRED EMBODIMENT

Now, the description will be made for the ink supply method for the printing press according to one embodiment of the present invention with reference to the drawings attached hereto.

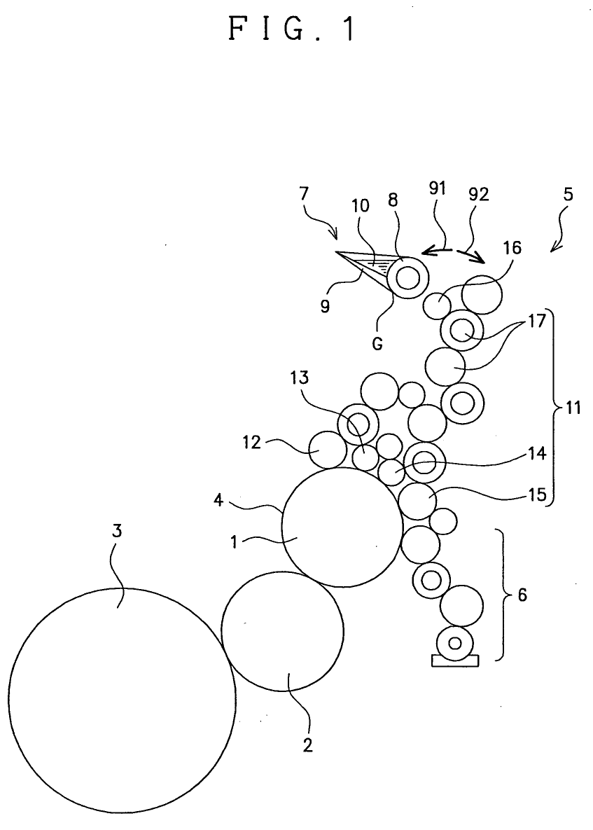

FIG. 1 illustrates one of printing units equipped in a multi-color sheet offset press. The printing units each includes a plate cylinder 1 on which a printing plate 4 is mounted, a blanket cylinder 2, an impression cylinder 3, an ink supply unit 5 for supplying ink to the printing plate 4, and a water supply unit 6 for supplying water to the printing plate 4. The ink supply unit 5 includes an ink fountain 7 that is made up of an ink fountain roller 8 and a blade 9, which together form a gap G therebetween, allowing ink 10 reserved in the ink fountain 7 to flow through the gap G and be supplied to the outer circumference of the ink fountain roller 8 kept in rotation. The gap G is adjustable in dimension or size by opening and closing the blade 9 so that the greater the opening degree of the blade 9, the wider the gap G, allowing an increased amount of ink to flow out from the ink fountain 7, and on the other hand, the smaller the opening degree of the blade 9, the narrower the gap G, allowing a decreased amount of ink to flow out from the ink fountain 7. The blade 9 is made up of plural ink fountain keys aligned parallel to the axis of the ink fountain roller 8 (a widthwise direction of a substrate to be printed), in which the opening degrees of the plural ink fountain keys are adjustable independently of each other. The opening degrees of the ink fountain keys are preset based on an image area ratio of the printing plate 4 prior to staring each printing operation.

Ink having flown from the ink fountain 7 onto the ink fountain roller 8 is supplied to the printing plate 4 via an ink roller group 11 made up of a large number of ink rollers 17. The ink rollers 17, which are located parallel to the ink fountain roller 8, the plate cylinder 1 and the like, are held in contact with each other so as to transfer ink from the most upstream ink roller to the most downstream ink roller one by one. Form rollers 12, 13, 14, 15 located on the most downstream side of the printing unit are designed to be capable of moving toward and away from the plate cylinder 1 and being held away from the plate cylinder 1 during the sheet feeding operation is stopped or suspended.

An ink transfer roller 16 is located between the most upstream ink roller 17 and the ink fountain roller 8 so as to be able to move back and forth therebetween. This ink transfer roller 16 reciprocatingly moves back and forth in the directions represented by arrows 91, 92 between the above two rollers so as to transfer ink adhered to the outer circumference of the ink fountain roller 8 to the ink roller 17. This ink transfer action will be hereinafter sometimes referred to an ink-drawing-out action. Thus, ink 10 reserved in the ink fountain 7 is transferred through the ink fountain roller 8 to the ink rollers 17 by the ink-drawing-out action of the ink transfer roller 16, and then to the form rollers 12, 13, 14, 15, which are timely brought into contact with the printing plate 4, thereby allowing ink to be supplied to the printing plate 4.

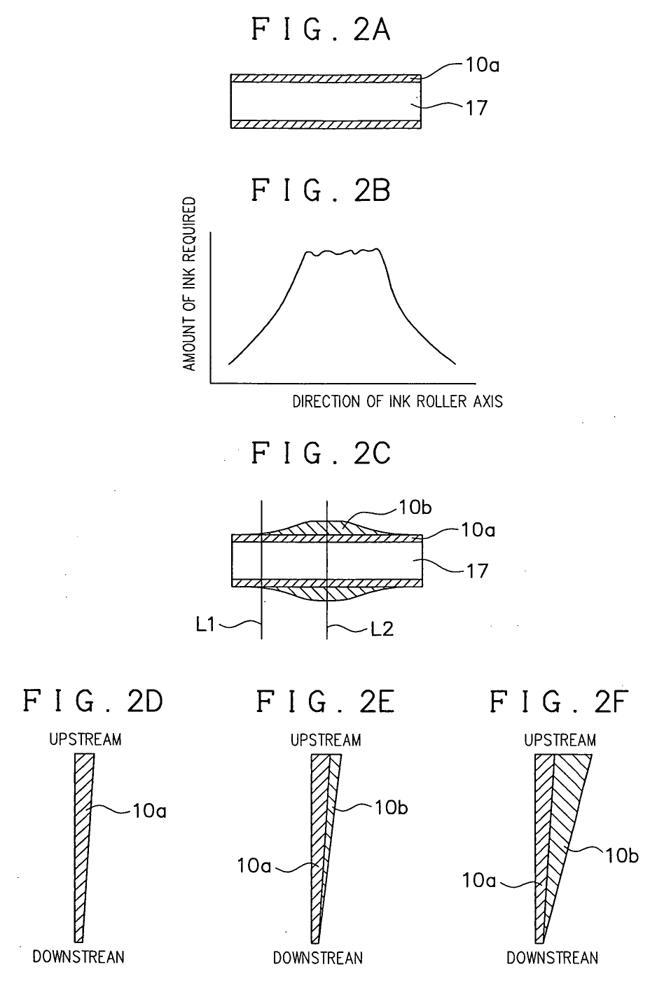

It is to be noted that at least a minimum amount of ink film required for an upcoming or next printing operation must be adhered to the respective ink rollers 17 in advance. FIG. 2A illustrates one of the ink rollers 17 with a basic ink film 10a adhered thereto. The basic ink film 10a has a uniform thickness distribution along the axis of the ink roller 17. An image ink film 10b having a thickness distribution corresponding to an image of the printing plate 4 for the next printing operation is overlaid on the basic ink film 10a. The thickness distribution of the image ink film 10b is changed along the axis of the ink roller 17. For example, where an ink film thickness distribution as illustrated in FIG. 2B is required, the amount of ink flowing between each ink fountain key and the ink fountain roller 8 is adjusted by adjusting the opening degrees of the ink fountain keys independently of each other according to the measured image area ratio of the printing plate 4, thereby allowing ink to be supplied from the ink fountain 7 to the ink rollers 17 in a thickness or amount corresponding to the image of the printing plate 4, having the image ink film 10b overlaid on the basic ink film 10a having a uniform thickness distribution and hence building up a film thickness distribution corresponding to the image of the printing plate 4 on each of the ink rollers 7 along the axis thereof.

Ink adhered to the respective ink rollers 17 becomes gradually thinner as it transfers from the most upstream ink roller to the most downstream ink roller. Accordingly, the basic ink film 10a also becomes gradually thinner as it advances from the upstream side to the downstream side, as illustrated in FIG. 2D, while the image ink film 10b overlaid thereon also becomes gradually thinner, as illustrated in FIGS. 2E and 2F. The amounts of ink respectively corresponding to lines L1, L2 of FIG. 2C are illustrated in FIGS. 2E and 2F. These ink films are formed on the respective ink rollers 17 prior to starting each printing operation. Ink supply to the ink rollers 17 is stopped just before the end of each printing operation, while allowing printing of a given number of substrates with no supply of ink any more, thereby removing the image ink film 10b from each ink roller 17. Thus, only the basic ink film 10a is left on each of the ink rollers 17 when the printing operation is finished.

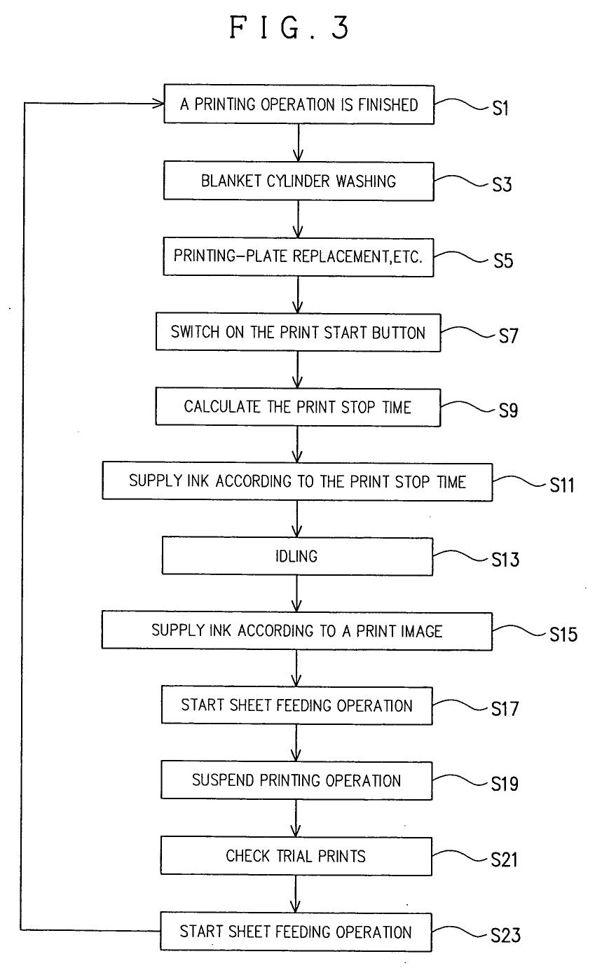

Now, the description will be made for the flow of the ink supply process according to this embodiment with reference to FIG. 3.

Every time a printing operation is finished (Step S1), a preparation for the next printing operation is started. When a given number of sheets assigned to each printing operation have been finished, this printing operation is considered as finished. And, this finishing of the printing operation is determined by detecting that the last sheet has been fed from a sheet feeding section. For example, a sensor may be disposed upstream to a sheet feeding cylinder (not shown) so as to detect sheets passing therethrough. Once the sensor detects the last sheet passing therethrough, it is determined that the last sheet has been fed. The time elapsed is measured from that moment so as to determine the time for which the printing operation is stopped (a print stop time).

The operator starts blanket cylinder washing upon finishing the printing of the last sheet (Step S3), which is made either manually or automatically by the printing press. In either case, after the blanket cylinder washing, printing-plate replacement is made (Step S5). This printing-plate replacement is also automatically made when the printing press is equipped with an imaging unit. That is, a used printing plate is wound onto a roll inside the plate cylinder and a new printing plate is loaded onto the plate cylinder. A print image is formed on this new printing plate by the imaging unit. In addition to this printing-plate replacement, another preliminary work such as sheet stacking in the sheet feeding section may be made, and sometimes the operator may take a rest before the next printing operation is started. Upon finishing all the preliminary works for the next printing operation, the operator presses a print start botton provided on an operation panel of the printing press (Step S7). By pressing the print start bottom, the printing press automatically performs the following operations.

First, the printing press calculates the time for which the printing operation has been stopped (a print stop time) (Step S9). This print stop time is the time from the end of the last printing operation to the start of the current printing operation. Specifically, as described above, the print stop time is calculated by summing the time elapsed after the last sheet has been fed and before the print start button is pressed and the time after the print start button has been pressed and before sheet feeding operation is actually started. Herein, the former time is automatically measured by the printing press for each operation, while the latter time is a fixed time previously set. This fixed time is determined based on a time required for forming the aforementioned ink film on each of the ink rollers 17, and therefore individually set for each printing press. This fixed time can be modified by the operator, using the operation panel, if necessary. In either case, the latter time remains constant whether the printing-plate replacement or other works are to be made or not, and stored in a memory part of the printing press.

Then, the amount of ink to be supplied from the ink fountain 7 is determined according to the calculated print stop time and then this determined amount of ink is supplied to the ink rollers 17 (Step S11). This determination is made so that the longer the print stop time the larger the amount of ink is supplied. The amount of ink is increased or decreased depending on the number of times at which the ink transfer roller 16 moves back and forth (the number of ink-drawing-out actions of the ink transfer roller 16). For example, when the print stop time is 10 minutes, the ink-drawing-out actions are made three times, and similarly for 20 minutes: five times, and for 60 minutes: 15 times. That is, the longer the print stop time, the larger the number of ink-drawing-out actions are made, so that the amount of ink to be transferred onto the ink rollers 17 is increased. Since the basic ink film 10a, which has a minimum amount of ink required during the printing operation, is left on each ink roller 17, ink newly supplied is overlaid on the basic ink film 10a.

After supplying an amount of ink corresponding to the print stop time to the ink rollers 17, relevant parts or members are idled so as to stop ink supply from the ink fountain 7 without ink-drawing-out actions, allowing the rotations of the ink rollers 17 for even film thickness distribution along the axis of the ink rollers 17, thereby forming the basic ink film 10a (Step S13). Then, the opening degrees of the ink fountain keys are adjusted to have a proper condition, under which the ink-drawing-out actions are performed a given number of times, thereby overlaying the image ink film 10b for the current printing operation (Step S15). Thus, the ink supply process before starting the printing operation is finished.

Then, the sheet feeding operation is automatically started, thereby starting the printing operation (Step S17). Before printing final prints, a given number of trial prints (e.g., 100 prints) are printed to check whether required production levels are achieved. During the trial prints are checked, the sheet feeding is suspended so as to suspend the printing operation (Step S19). This suspension of the sheet feeding may be made by the operator using the operation panel, or may be automatically made after a given number of sheets are printed. In either case, the trial prints are checked upon suspension of the printing operation (Step S21). The checking of these trial prints involves measuring the print density. The operator measures the print density by a density measuring device and compares the measured value with a target value so that if necessary, the amount of ink is increased or decreased. Where the print density is relatively low, the ink-drawing-out action by the ink transfer roller 16 is made while the printing operation is suspended, thereby supplementing a given amount of ink to the ink rollers 17. Then, the sheet feeding and hence the printing operation are resumed. Contrarily, where the print density is relatively high, the sheet feeding is resumed without supplementing ink, and after resumption of the sheet feeding, the ink supply is suspended for a given time. That is, the ink-drawing-out action by the ink transfer roller 16 is not made until after the expiration of a given time since the resumption of the printing operation, thereby decreasing the amount of ink on each of the ink rollers 17. This operation is repeated until the print density is lowered to the target density. Once the print density reaches the target density, the printing press starts printing final prints (Step S23).

Thus, even if the print stop time between the printing operations is longer than usual, causing great change of the ink character before the start of the next printing operation, it is possible to prevent in advance lowering of the print density by supplying a relatively large amount of ink to the ink rollers 17. Where the print stop time between the printing operations is shorter than usual, the method of the present invention can properly deal with this situation by decreasing the amount of ink supplied to the ink rollers 17. Also, checking of the trial prints is made while the printing operation is suspended. Hence, broke is not caused during this checking operation. It is to be noted that this stop of the printing operation for checking the trial prints does not extend for such a long time as to cause substantial change to the ink characteristic.

As described above, in this embodiment, in consideration of the change in ink characteristic, which may occur before the next printing operation is started, the amount of ink to be supplied is controlled in advance prior to starting the printing operation, and the occurrence of broke during the checking of a trial print is prevented as much as possible. As a result, the occurrence of broke in the entire operation can be greatly reduced.

This specification is by no means intended to restrict the present invention to the preferred embodiments set forth therein. Various modifications to the method of supplying ink to ink rollers in the printing press, as described herein, may be made by those skilled in the art without departing from the spirit and scope of the present invention as defined in the appended claims.

What is claimed is:

1. A method of supplying a given amount of ink to ink rollers in a printing press in advance before starting a current printing operation to be subsequently made after a last printing operation, comprising adjusting the amount of ink to be supplied to the ink rollers in advance before starting the current printing operation, according to the time elapsed between the end of the last printing operation and the start of the current printing operation.

2. A method of supplying ink to ink rollers in a printing press comprising starting a printing operation, thereby producing a given number of prints, and suspending said printing operation, during which the print density for the given number of prints is measured, so that where said print density is lower than a target value, ink is supplied to the ink rollers with said printing operation kept suspended, and where the print density is higher than the target value, said printing operation is resumed while suspending ink supply to the ink rollers for a given time after resumption of the sheet feeding.
